(19) United States
(12) Patent Application Publication
(10) Pub. No.: US 2006/0063053 A1
(43) Pub. Date: Mar. 23, 2006

(54) Direct methanol fuel cell, method for detecting fuel level, and method for detecting methanol concentration

(76) Inventors: Masaru Higashionji, Katano-shi (JP); Kenji Hasegawa, Hirakata-shi (JP); Masafumi Shimotashiro, Katano-shi (JP); Masaru Odagiri, Kawanishi-shi (JP); Toshiyuki Aoyama, Settsu-shi (JP)

Correspondence Address: WENDEROTH, LIND & PONACK L.L.P., 2033 K. STREET, NW, SUITE 800, WASHINGTON, DC, 20006, US

(21) Appl. No.: 11/221,732

(22) Filed: Sep. 9, 2005

(30) Foreign Application Priority Data
Sep. 16, 2004 (JP) P2004-269464
Aug. 5, 2005 (JP) P2005-228262

(51) Int. Cl. H01M 8/10; H01M 8/08; H01M 8/04

(52) U.S. Cl. 429/30; 429/46; 429/34; 429/22; 429/13

(57) ABSTRACT

The present invention provides a direct methanol fuel cell in which an amount of liquid fuel having methanol aqueous solution changed to acidic is manageable, a method for detecting a liquid level, and a method for detecting a methanol concentration. For the liquid fuel, the fuel in which a pH value is adjusted to about 2.5 to about 3.0 in advance in a state before start of electric power generation is used. Thus, the change in electrical conductivity of the liquid fuel immediately after the start of the electric power generating operation and during the electric power generating operation period is made small, and by measuring an impedance value of two level electrodes, the level change of the liquid fuel can be detected while suppressing influence of the impedance value caused by the change in pH value.

### TECHNICAL FIELD

The present invention relates to fuel cells, in particular, to a direct methanol fuel cell (DMFC) for supplying methanol aqueous solution directly to an anode electrode to generate power, a method for detecting fuel level applied to the direct methanol fuel cell, and a method for detecting methanol concentration, applicable to the direct methanol fuel cell, for detecting the methanol concentration of the methanol aqueous solution.

### BACKGROUND OF THE INVENTION

The secondary cell currently used in portable electronic apparatus such as, a portable phone, a personal digital assistance, a note-book personal computer, a portable audio and a portable visual equipment is recyclable through charging but requires a charging equipment and charging time. Thus, a cell that can be continuously used over a long period of time without the charging operation is desired and a fuel cell is provided for such cell.

In the early developing stage of the fuel cell, an acid electrolytic solution type fuel cell using methanol, sulfuric acid and the like as liquid fuel have been developed (refer to e.g., JP,1983-165274,A and JP,1988-136472,A).

In such cells, the fuel is supplied into the acid electrolytic solution which is called as an anolyte and has, for example, sulfuric acid of 0.5 to 3.0 mol %/liter, and an oxidative reaction of methanol is performed in a fuel chamber. The disadvantage of this type of fuel cell is that corrosivity due to the sulfuric acid of the electrolyte is high, and when taking temperature increase by the reaction into consideration, there is a problem that corrosive resistant material must be used for the material constituting the cell.

A direct methanol fuel cell (DMFC) in which power generation can be semi-permanently continued as long as the fuel is being supplied is given attention for improving the above disadvantages.

The basic configuration of the direct methanol fuel cell includes an anode electrode to where the liquid fuel of the methanol aqueous solution is supplied, a cathode electrode to where air for oxidation is supplied, and a solid polymer electrolyte membrane arranged sandwiched between the anode electrode and the cathode electrode. In such direct methanol fuel cell, power generation is performed through reaction of the following equation.
Anode electrode CH₃OH+H₂O→6H⁺+6e⁻+CO₂
Cathode electrode 6H⁺+6e⁻+3/2O₂→3H₂O

That is, at the anode electrode, methanol and water are reacted under conditions of catalysis containing platinum and ruthenium thereby generating hydrogen ions, electrons and carbon dioxide. The electrons are output to the outside as electrical power through the anode electrode. The hydrogen ions are conducted to the cathode electrode through the electrolyte membrane and united with oxygen to become water. In this way, the direct methanol fuel cell performs power generation by consuming methanol and water, and generates water of three times the output of water reacting with methanol through chemical reaction. Therefore, the feature of the direct methanol fuel cell is that power generation is basically possible by supplying only methanol and water does not need to be supplied (refer to e.g., U.S. Pat. No. 5,599,638).

In the invention of U.S. Pat. No. 5,599,638, the hydrogen ion conductive membrane is included as the solid polymer electrolyte membrane, more specifically, the electrolyte membrane is a copolymer of tetrafluoroethylene and perfluorovinylether sulfonic acid. Although the liquid fuel conventionally contained the acid electrolyte such as sulfuric acid, by using such electrolyte membrane, power generation using liquid fuel that does not contain acid electrolyte becomes possible. Therefore, the various conventional disadvantages in the material to be used and the like that takes corrosive resistance into consideration for the liquid contacting parts is resolved.

On the other hand, in the direct methanol fuel cell, when the methanol of the fuel and water react at the anode electrode thereby generating carbon dioxide gas and hydrogen ions in the power generation process, formaldehyde, and further, formic acid, although at a small amount, are generated as impurities. Moreover, at the cathode electrode as well, when the methanol that has passed the electrolyte membrane reacts with oxygen through a so-called cross over phenomenon, the above impurities are generated. Thus the formaldehyde and formic acid are also contained at a small amount in the water generated at the cathode electrode. However, the formic acid generated in such a way is a very small amount, and thus does not need to be seen as a problem compared to the above mentioned sulfuric acid, and also does not particularly cause problems in power generating operation.

In the direct methanol fuel cell, on the other hand, the fuel must be continuously supplied in order to proceed with the power generation semi-permanently without the charging process. To this end, management of the fuel amount in the fuel storage tank becomes important. As a method for detecting the remaining amount of the liquid, generally, in addition to visual observation, methods for measuring the entire weight, detecting changing of the light transmissivity at a reference position and the like are known, but the configurations thereof are complex and requires extreme precision, and thus they cannot convert it to an electric signal with an inexpensive and simple circuit configuration.

Further, in the direct methanol fuel cell, the formic acid is generated as above in power generating operation, which formic acid changes the methanol aqueous solution from neutral to acidic.

Therefore, an object of the present invention is to provide a direct methanol fuel cell in which power generation is carried out without any problem using the liquid fuel consisting of methanol aqueous solution changed to acidic, and aims to provide a direct methanol fuel cell in which the fuel amount of the liquid fuel consisting of methanol aqueous solution changed to acidic is manageable, and also aims to provide a method for detecting the liquid level that can be implemented in the direct methanol fuel cell.

Further, management of the concentration of the methanol aqueous solution acting as fuel is an important item in power generation by the direct methanol fuel cell. That is, in order for the methanol and water to react by catalyst and generate hydrogen ions and electrons, a suitable concentration range is given for the methanol aqueous solution, where an example is given in which the concentration of the methanol aqueous solution of about 3-5% by weight is suitable. The concentration of the methanol aqueous solution can be measured by detecting the change in dielectric constant, but in the methanol aqueous solution that has been changed to acidic from the neutral methanol aqueous solution by the generation of the formic acid, the concentration of the methanol aqueous solution cannot be accurately measured since the change in electrical conductivity of the methanol aqueous solution becomes the cause of error.

Therefore, another object of the present invention further is to provide a method for detecting methanol concentration that can be implemented in the direct methanol fuel cell.

### SUMMARY OF THE INVENTION

The present invention is configured in the following way to achieve the above objects.

Specifically, according to the first aspect of the present invention, there is provided a direct methanol fuel cell comprising:

an anode electrode configured to be supplied with a liquid fuel of methanol aqueous solution; a cathode electrode configured to be supplied with air for oxidation; and a solid polymer electrolyte membrane configured to be sandwiched between the anode electrode and the cathode electrode and contain a hydrogen ion conductive membrane,

the direct methanol fuel cell configured to generate an electric power through chemical reaction at the anode electrode and the cathode electrode,

the methanol aqueous solution, supplied to the anode electrode, containing formic acid at a concentration having a lower limit of 0.05% by weight and an upper limit of 0.30% by weight in advance before start of the chemical reaction.

In the first aspect, a methanol concentration determining device configured to obtain the methanol concentration in the liquid fuel may be included.

Further, the methanol concentration determining device may include:

an anode electrode configured to be supplied with the liquid fuel; a cathode electrode configured to be supplied with air for oxidation; a solid polymer electrolyte membrane configured to contain a hydrogen ion conductive membrane; and a voltmeter configured to measure an output voltage obtained from the anode electrode and the cathode electrode through the chemical reaction at the anode electrode and the cathode electrode,

the methanol concentration determining device configured to determine the methanol concentration based on relationship between the output voltage and the methanol concentration.

Also, the methanol concentration determining device may include:

a wave transmitting part and a wave receiving part configured to be immersed in the liquid fuel; and a propagation speed determining part connected to the wave receiving part and configured to determine a propagation speed of an oscillating wave propagating through the liquid fuel from the wave transmitting part to the wave transmitting part,

the methanol concentration determining device configured to determine the methanol concentration based on relationship between the propagation speed and the methanol concentration.

In the first aspect, the direct methanol fuel cell may further comprise:

two electrodes configured to be arranged with immersed in the liquid fuel; and an impedance measuring device electrically connected to the electrodes and configured to measure an impedance between the electrodes and determine state of the liquid fuel.

The object of measurement by the impedance measuring device includes temperature measurement of the liquid fuel other than the liquid level detection of the liquid fuel. Thus, the impedance measuring device has a sensor function for the liquid fuel.

According to the second aspect of the present invention, there is provided a direct methanol fuel cell comprising:

an electric power generating part including an anode electrode supplied with a liquid fuel of methanol aqueous solution, a cathode electrode supplied with air for oxidation, and a solid polymer electrolyte membrane sandwiched between the anode electrode and the cathode electrode and containing a hydrogen ion conductive membrane; and configured to generate an electric power through chemical reaction at the anode electrode and the cathode electrode;

a fuel tank configured to store the methanol aqueous solution supplied to the anode electrode, the methanol aqueous solution containing formic acid at a concentration having a lower limit of 0.05% by weight and an upper limit of 0.30% by weight in advance before start of the chemical reaction; and

a liquid level detecting device including two level electrodes configured to be arranged at a position where an immersed amount of the level electrodes changes in accordance with level change of the liquid fuel in the fuel tank, and a level detecting circuit electrically connected to the level electrodes and configured to send a detected value according to the level of the liquid fuel; and the liquid level detecting device configured to detect the level of the liquid fuel based on relationship between the detected value and the immersed amount.

According to the third aspect of the present invention, there is provided a method for detecting a liquid level of a liquid fuel in a direct methanol fuel cell including an anode electrode configured to be supplied with a liquid fuel of methanol aqueous solution, a cathode electrode configured to be supplied with air for oxidation, and a solid polymer electrolyte membrane configured to be sandwiched between the anode electrode and the cathode electrode and contain a hydrogen ion conductive membrane; the direct methanol fuel cell configured to generate an electric power through chemical reaction at the anode electrode and the cathode electrode, the method comprising:

adjusting the liquid fuel of the methanol aqueous solution supplied to the anode electrode so as to contain formic acid at a concentration having a lower limit of 0.05% by weight and an upper limit of 0.30% by weight in advance before start of the chemical reaction;

arranging two level electrodes so that an immersed amount of the level electrodes changes in accordance with level change of a concentration adjusted liquid fuel; and

detecting the level of the liquid fuel based on relationship between an impedance between the level electrodes and the immersed amount.

Further, according to the fourth aspect of the present invention, there is provided a method for detecting a methanol concentration of a liquid fuel in a direct methanol fuel cell including an anode electrode configured to be supplied with a liquid fuel of methanol aqueous solution, a cathode electrode configured to be supplied with air for oxidation, and a solid polymer electrolyte membrane configured to be sandwiched between the anode electrode and the cathode electrode and contain a hydrogen ion conductive membrane; the direct methanol fuel cell configured to generate an electric power through chemical reaction at the anode electrode and the cathode electrode, the method comprising:

supplying a liquid fuel of methanol aqueous solution containing formic acid at a concentration having a lower limit of 0.05% by weight and an upper limit of 0.30% by weight in advance before start of chemical reaction to the anode electrode of a concentration detector, the concentration detector configured to include the anode electrode, the cathode electrode, and the solid polymer electrolyte membrane, a load of constant value being connected to the anode electrode and the cathode electrode, and generate an electric power through chemical reaction at the anode electrode and the cathode electrode; and

determining a methanol concentration through output change obtained from the anode electrode and the cathode electrode of the concentration detector.

According of the fifth aspect of the present invention, there is provided a method for detecting a methanol concentration of a liquid fuel in a direct methanol fuel cell including an anode electrode configured to be supplied with a liquid fuel of methanol aqueous solution, a cathode electrode configured to be supplied with air for oxidation, and a solid polymer electrolyte membrane configured to be sandwiched between the anode electrode and the cathode electrode and contain a hydrogen ion conductive membrane, the direct methanol fuel cell configured to generate an electric power through chemical reaction at the anode electrode and the cathode electrode, the method comprising:

supplying a liquid fuel containing formic acid at a concentration having a lower limit of 0.05% by weight and an upper limit of 0.30% by weight in advance before start of the chemical reaction to the anode electrode;

propagating an oscillating wave in the liquid fuel and then obtaining a propagation speed of the oscillating wave; and

determining a methanol concentration based on relationship between the propagation speed and the methanol concentration.

In a fuel cell including an electric power generating part having a solid polymer electrolyte membrane which is arranged between an anode electrode and a cathode electrode and includes a hydrogen ion conductive membrane consisting of copolymer of tetrafluoroethylene and perfluorovinylether sulfonic acid, the methanol aqueous solution not containing the acid electrolyte at the initial stage before the start of power generation acts as liquid fuel. This is because power generation becomes possible without any trouble even with the methanol aqueous solution not containing acid electrolyte by arranging the solid polymer electrolyte membrane of the above configuration.

On the other hand, even with the methanol aqueous solution not containing the acid electrolyte at the initial stage, the methanol is decomposed by starting power generation, thereby generating formaldehyde and further formic acid, and the methanol aqueous solution that was neutral at the initial stage gradually becomes acidic. However, it became evident from the experiments of the applicants that an electrical conductivity or acidity of the methanol aqueous solution is approximately about 2.5 to about 3.0 in pH value and remains substantially constant even after the power generation over a long period of time.

The present invention thus, as mentioned above, uses the formic acid generated as a by-product of the process of the methanol reacting with water under catalyst, and further, uses the phenomenon that reaction of the methanol by catalysis and reaction of the formic acid by catalysis achieve a state of equilibrium within a certain range, that is, a state in which the formic acid is not excessively generated even if the power generating operation is continued and thus the formic acid is present at a substantially constant concentration. More specifically, the formic acid is mixed with the liquid fuel made available for power generation in advance before the start of power generation so as to achieve the state in which the formic acid is present at substantially constant concentration, that is, the pH value of the liquid fuel becomes about 2.5 to about 3.0.

The formic acid amount to be mixed must have an adding amount of stabilizing the electrical conductivity of the liquid fuel as a lower limit, and a maximum adding amount in a range that does not cause corrosion and the like on the fuel cell material as an upper limit. In embodiments, the adding amount of about 0.05% to about 0.3% by weight with respect to the methanol aqueous solution is the suitable range. The reasons for selecting such adding amount range will be explained below.

Namely, as an adverse effect of injecting a small amount of formic acid to the methanol aqueous solution, or the fuel, the corrosive action by the formic acid on the liquid contacting parts of the fuel cell becomes a concern. The formic acid aqueous solutions of 0.3% by weight, 1% by weight, and 10% by weight are formed, and a part of steel product generally used as a material for constituting the liquid contacting parts of the fuel cell is immersed into these formic acid aqueous solutions and is left to stand under high temperature and then the degree of corrosion at the immersion interface is observed. As a result, in the formic acid aqueous solution of 0.3% by weight, abnormality of foaming and the like does not occur, but in the formic acid aqueous solution of 10% by weight, change in color is observed within 24 hours from immersion, and in the formic acid aqueous solution of 1% by weight, change in color is observed in 96 hours. In the formic acid aqueous solution of 0.3% by weight, change in color is not observed even after 240 hours.

On the other hand, as apparent from FIG. 5, as a range in which the pH value in the liquid fuel stabilizes, the formic acid needs to exist at a concentration of greater than or equal to 0.05% by weight.

Therefore, it becomes clear that the pH value in the liquid fuel is stabilized if the formic acid at a concentration of 0.05% by weight for the lower limit and 0.3% by weight for the upper limit is injected, and the problem of corrosion practically does not occur at the liquid contacting parts constituting the fuel cell. The power generating operation not different from the prior art is obviously recognized to continue at the liquid fuel injected with formic acid at the above concentration.

Further, as mentioned above, methanol is mixed with water at the anode electrode thereby generating hydrogen ions and electrons under catalysis. The mobility of the hydrogen ions is known to enhance in acidic liquid fuel than in neutral liquid fuel. Thus, by adding the formic acid to the neutral methanol aqueous solution in advance, power enhancement during power generation can be accomplished. If the adding amount of the formic acid is 0 to less than about 0.05% by weight, the pH value in the liquid fuel does not stabilize, and thus the generated electric power may become unstable. If, on the other hand, the adding amount of the formic acid is an amount exceeding about 0.3% by weight, the above mentioned corrosion problem may become a concern. Therefore, by having the adding amount of about 0.05 to about 0.3% by weight with respect to the methanol aqueous solution not containing acid electrolyte in the initial stage, a stable electric power can be obtained, and the problem of corrosion does not occur, and further, the amount of the electric power generation is enhanced compared to that of the neutral methanol aqueous solution.

On the other hand, the liquid fuel must be supplied continuously to the electric power generating part in order to maintain the electric power generation and thus management of a remaining amount of the liquid fuel becomes necessary. Two level electrodes are arranged as a detecting device of the level of the liquid fuel, that is, the remaining amount in the fuel cell at a position where an immersed amount of the level electrodes changes according to the level change of the liquid fuel, and the level of the liquid fuel is detected based on a relationship between an impedance value of the level electrodes and the immersed amount by a level detecting circuit.

The relationship between the change in level of the liquid fuel and the change in impedance value by the level electrodes shows correlation in a state the electrical conductivity, more specifically, the pH value of the liquid fuel is constant or substantially constant. Thus, in the initial stage of the electric power generating operation, that is, when the liquid fuel is in a substantially neutral state and is substantially constant, the level of the liquid fuel can be detected based on the change of the impedance value.

This will be explained more specifically. When two level electrodes are immersed in the methanol aqueous solution not containing the formic acid, the level electrodes operate so as to detect an electric capacitance as the impedance. The level detecting circuit outputs a detected voltage waveform 201 shown in (b) of FIG. 6 which is differentiated by a capacitance of the level electrodes and a fixed resistance connected in series with the level electrodes and arranged at the level detecting circuit. In (a) of FIG. 6, it shows a driving voltage waveform oscillated by an oscillator arranged in the level detecting circuit to measure the impedance of the level electrodes.

The electrostatic capacitance value of the level electrodes increases in accordance with the immersed amount of the level electrodes. Thus, since a time constant of differentiation increases, a peak-peak value 202 of the detected voltage waveform increases. That is, when the immersed amount of the level electrodes increases, the detected voltage or the peak-peak value 202 increases. FIG. 7 shows the relationship between the detected voltage and the immersed amount of the level electrodes of when the pH value of the liquid fuel is 6.5. As apparent from FIG. 7, when the immersed amount of the level electrodes into the liquid fuel increases, the detected voltage also increases. Thus, it is determined that the level electrodes operate as a sensor for detecting the level. Assuming a dielectric constant in air is 1, a dielectric constant of the methanol aqueous solution is about 80 times that, and when the exposed portion of the level electrodes is completely immersed in the neutral methanol aqueous solution, the electrostatic capacitance of about 20 pF is shown as one example.

However, the formic acid is generated as described above with the electric power generation proceeding, and the liquid fuel rapidly changes to acidic as shown in FIG. 5. The impedance value is also influenced by the pH value of the liquid fuel. So, in region 210 where the pH value of the liquid fuel rapidly changes with increase in formic acid concentration, it becomes not to be able to determine whether the change of the detected voltage value is caused by the level change of the liquid fuel or by the change in pH value of the liquid fuel. Thus, in a case that the liquid level detecting device including the level electrodes and the level detecting circuit is used in the region 210 where the pH value rapidly changes, some contrivance, for example, a method and the like of separately measuring the pH value of the liquid fuel while correcting the detected output value by the level electrodes based on the measurement value is required.

FIG. 8 shows relationship between the detected voltage and the immersed amount of the level electrodes for when the pH value of the liquid fuel is 4.5, 3.7, and 3.4 is shown.

When the liquid fuel is in the acidic state, the waveform of the detected voltage output from the level detected circuit is different from that of in the neutral state. Namely, when the pH value of the liquid fuel is less than or equal to about 4, the impedance at the level electrodes changes so as to regard the impedance from a state of electrostatic capacitance component to a state of effective resistance component. The reason is that since the ion electric conductivity increase when the pH value of the liquid fuel decreases, the same effect as a case that the resistance component is connected in parallel to the electrostatic capacitance of the level electrodes formed by two parallel wires is obtained, and the impedance of the level electrodes can be considered to be a sufficiently small effective resistance compared to the electrostatic capacitance. Thus, waveform of the detected voltage output from the level detecting circuit is a rectangular waveform as shown in (c) of FIG. 6. Further, as shown in FIG. 8, as the pH value becomes smaller, the change in detected voltage with respect to the immersed amount of the level electrodes becomes larger.

As described above, and as shown in FIG. 5, although the formic acid is generated with the electric power generating operation, since the formic acid is a by-product in decomposition of methanol, the formic acid cannot be unilaterally increased. Thus, the pH value of the liquid fuel is settled in the vicinity of about 3.

Therefore, in a minor change region 211 in which the pH value and the electrical conductivity gradually changes shown in FIG. 5, the level change of liquid fuel again becomes detectable in the liquid level detecting device.

According to the above explanation, the liquid level detecting device is able to detect the level change of the liquid fuel at the minor change region 211 where the pH value and the electrical conductivity of the liquid fuel has no change or has substantially no change, or the pH value of the methanol aqueous solution acting as liquid fuel lowers only to substantially about pH value of 2.5 and is substantially about pH 3 to 2.5 irrespective of the electric power generating time.

A method for correcting the detected output value by a pH value of the liquid fuel measured separately may be considered, but it is unsuitable in terms of practicality and cost.

So, the present invention uses the fact that the pH of the methanol aqueous solution becomes about 3 and becomes substantially constant in the vicinity of the value of 3 through the electric power generating operation. That is, in the present invention, pH-pre-adjusted liquid fuel is used. The pH-pre-adjusted liquid fuel is liquid fuel that the minor change region 211 is formed intentionally by adding the formic acid to the fresh methanol aqueous solution of before the electric power generation, that is, to liquid fuel not containing acid electrolyte such as the formic acid, and the pH value of the liquid fuel is set in advance to about pH 2.5 to 3.0. Thus, from the start of the electric power generation and thereafter, the level of the liquid fuel can be detected by the liquid level detecting device without hardly being influenced by the change in the electrical conductivity or the pH value of the liquid fuel. It is to be noted that the adding amount of the formic acid to make the pH value of the liquid fuel set about 2.5 to about 3.0 is about 0.05 to about 0.30% by weight. Further, as an acid electrolyte added to perform pH adjustment, the formic acid is one of choices from the point of a substance originally generated through the decomposition of the methanol aqueous solution, but is not limited to the formic acid as long as the pH value can be adjusted.

One example of a method for adding the formic acid to the liquid fuel will be explained. For instance, a methanol aqueous solution of 5% by weight is made by mixing 25 grams of methanol with respect to 475 grams of water, and formic acid of 0.09 grams is dropped therein. In this way, pH value of the above methanol aqueous solution becomes about 3.6. When a double amount of 0.18 grams of the formic acid is dropped, the pH value becomes about 3.2, and thus it is understood that pH adjustment by the formic acid is relatively easy.

According to experiments of the applicants, with the addition of formic acid of an extremely small amount as described above, the pH value of the liquid fuel changes but adverse effect such as corrosion caused by the acid does not occur.

Further, even when the electric power generation is performed using liquid fuel of pH value 2.8 added with the formic acid, electric power generation properties as conventional is obtained and no problem is found. The pH value stabilized at around 2.7 even after continuing the electric power generation for 10 hours, and after continuing the electric power generation for 96 hours.

Even in the minor change region 211, as shown in FIG. 5, the pH value of the liquid fuel slightly changes. Thus, the change in electrical conductivity and pH value influence the liquid level detection by the level electrodes and may cause a slight error. Thus, in order to correct the change in pH value, it may be designed that reference electrodes are arranged in addition to the level electrodes and a correction circuit part is arranged in the level detecting circuit. The reference electrodes are arranged at a position completely submerged in the liquid fuel regardless of the level change of the liquid fuel, and have the same configuration as the level electrodes. The correction circuit part corrects detecting error of the liquid level at the level electrodes caused by the change of the pH value of the liquid fuel on the basis of impedance value of the reference electrodes as the reference. Thus, under a condition in which the pH value of the liquid fuel is uniform and no difference exists in the pH value of the liquid fuel at each arranging position of the level electrodes and the reference electrodes, the level of the liquid fuel can be more accurately detected by further arranging the reference electrodes.

Although of a small amount, since the formic acid is contained in the liquid fuel as described above, the level electrodes and the reference electrodes are made of materials having corrosion resistance, preferably, platinum or gold etc. Alternatively, platinum or gold plating may be performed.

In the above explanation, the methanol aqueous solution is used as an example of liquid fuel, but liquid fuel is not limited thereto and undiluted methanol liquid may be used.

Moreover, by arranging an impedance measuring device for measuring an impedance value using an electrode with respect to the liquid fuel in which the formic acid is mixed in advance and the pH value is adjusted, it may act as a sensor function for detecting a state of the liquid fuel in addition to detecting the liquid level of the liquid fuel. One example of such sensor function is temperature measurement of the liquid fuel.

According to the direct methanol fuel cell of the first aspect of the present invention, by adding the formic acid at an adding amount of about 0.05 to 0.3% by weight to the methanol aqueous solution not containing acid electrolyte at the initial stage, a stable electric power generation can be obtained, problem of corrosion does not arise, and the power generating amount can be enhanced compared to the neutral methanol aqueous solution.

According to the direct methanol fuel cell of the second aspect and a method for detecting the liquid level of the third aspect of the present invention, since the liquid fuel in which the pH value is adjusted to about 2.5 to about 3.0 in advance in a state of starting the electric power generation, the change in the electrical conductivity of the liquid fuel immediately after the start of the electric power generation and during the electric power generation is small. Therefore, the liquid level can be detected easily with the impedance value of two level electrodes. Although acid electrolyte is added for adjustment of the pH value, when the formic acid is used for the acid electrolyte, addition of formic acid in advance does not arise any problem since the formic acid is a by-product consequently produced through the electric power generating operation when methanol aqueous solution is used as the liquid fuel. Further, since the formic acid is an intermediate product under catalysis, the concentration of the formic acid will not be further increased through continuation of the electric power generation.

According to the method for detecting methanol concentration of the fourth aspect of the present invention, the pH value of the liquid fuel is substantially constant regardless of the elapsed electric power generating time since methanol aqueous solution added with formic acid at 0.05 to 0.3% by weight for pH adjustment in advance is used. Further, although the concentration detector performs the power generation with liquid fuel, change in the electric power generation due to the load fluctuation does not arise because a load of constant value is connected. Thus, the methanol concentration is monitored according to the output voltage of the concentration detector based on the relationship between the output voltage of the concentration detector obtained in advance and the methanol concentration.

Further, according to the method for detecting methanol concentration according to the fifth aspect of the present invention, compared to the method for detecting concentration according to the fourth embodiment, the output voltage by the electric power generation is not required, and thus the liquid fuel is not consumed for the concentration measurement. Therefore, the liquid fuel can be more effectively used for the electric power generation.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1 is a view showing a configuration of a direct methanol fuel cell according to an embodiment of the present invention;

FIG. 2 is a perspective view of a fuel tank and an electric power generating part shown in FIG. 1;

FIG. 3 is a perspective view of a level electrode shown in FIG. 1;

FIG. 4 is a view showing one example of a circuit configuration of a level detecting circuit shown in FIG. 1;

FIG. 5 is a graph showing a relationship between an adding amount of formic acid and a pH value in the methanol aqueous solution;

FIG. 6 shows waveforms in the liquid level detecting device shown in FIG. 1, where (a) is a view showing an output waveform of an oscillator in the liquid level detecting device, (b) is a view showing an output waveform of the level detecting device in the liquid level detecting device shown in FIG. 1, and (c) is a view showing an output waveform of the level detecting device in the liquid level detecting device shown in FIG. 1;

FIG. 7 is a graph showing a relationship between an immersed amount of the level electrode shown in FIG. 1 and an output value of the level electrode when the pH value of the methanol aqueous solution is 6.5;

FIG. 8 is a graph showing a relationship between the immersed amount of the level electrode shown in FIG. 1 and the output value of the level electrode when the pH value of the methanol aqueous solution is 4.5, 3.7, and 3.4;

FIG. 9 is a perspective view showing a variant example of the direct methanol fuel cell shown in FIG. 1;

FIG. 10 is a view showing a fuel cell to which the level detecting circuit shown in FIG. 1 is applicable;

FIG. 11 is a perspective view showing one example of a portable electronic apparatus to which the direct methanol fuel cell shown in FIG. 1 is attachable;

FIG. 12 is a view showing a configuration of a correction circuit part shown in FIG. 9;

FIG. 13 is a graph showing a relationship between an electric power generated by the fuel cell and a methanol concentration;

FIG. 14 is a graph showing a relationship between a pH value in the methanol aqueous solution and an electric power generated by the fuel cell;

FIG. 15 is a view showing a direct methanol fuel cell, including a concentration detector, according to a second embodiment of the present invention;

FIG. 16 is a view showing a direct methanol fuel cell including one variant of the concentration detector shown in FIG. 15; and

FIG. 17 is a view showing a direct methanol fuel cell, including an impedance measuring device, according to a third embodiment of the present invention.

### DETAILED DESCRIPTION OF THE PREFERRED EMBODIMENTS

A direct methanol fuel cell, a method for detecting a liquid level performed in the direct methanol fuel cell, and a method for detecting a methanol concentration executable in the direct methanol fuel cell will now be explained with reference to the drawings. In each figure, the same reference characters are denoted for the same components.

### First Embodiment

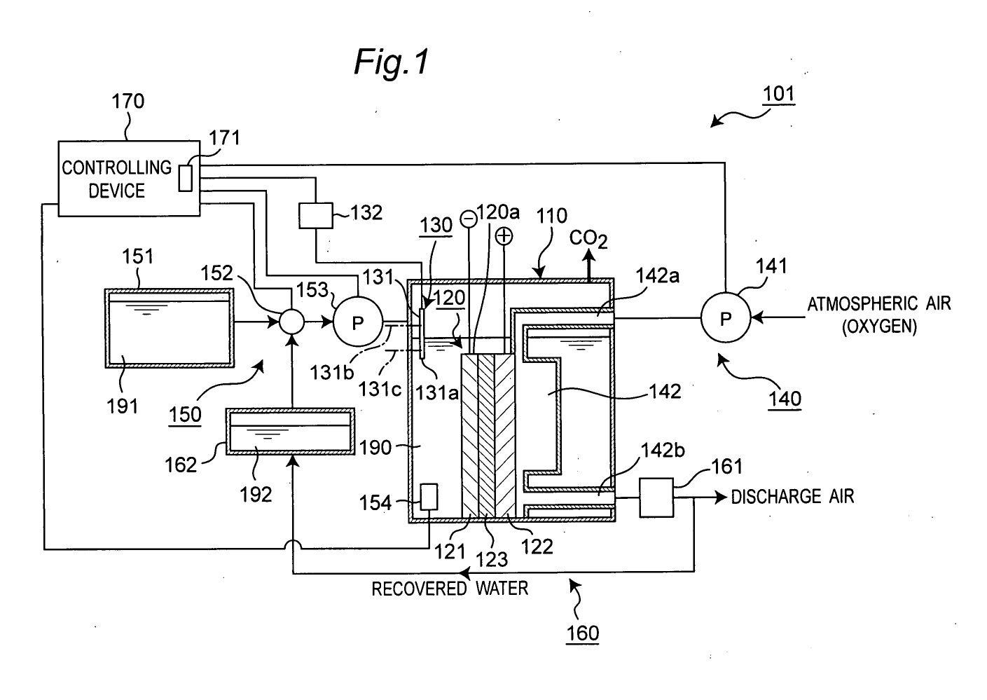

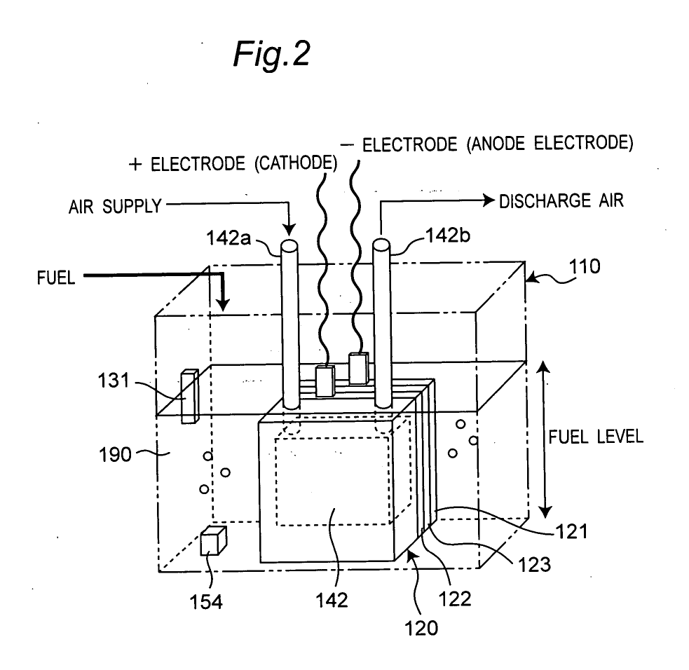

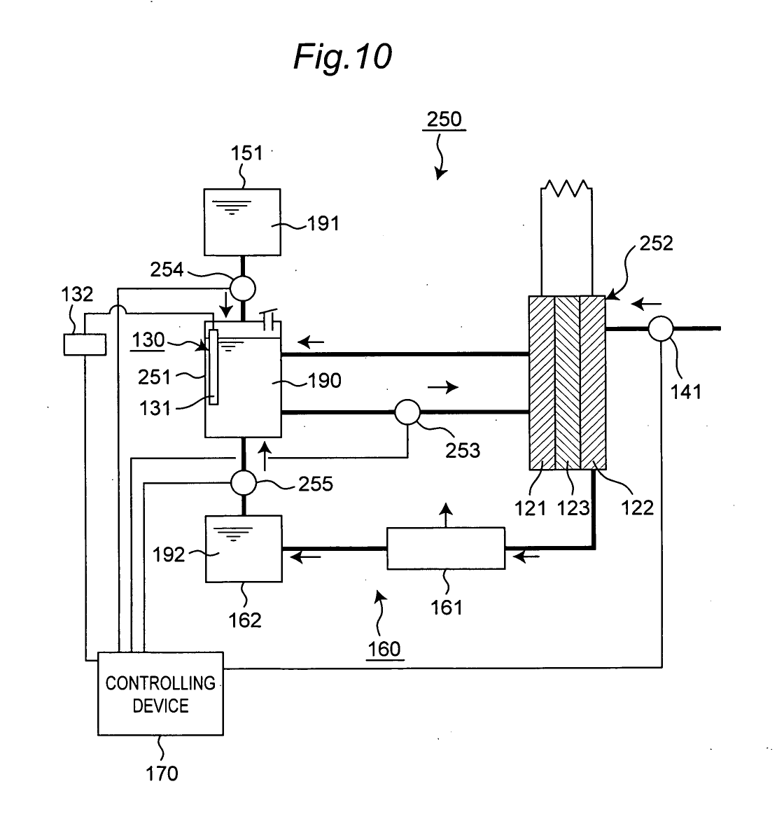

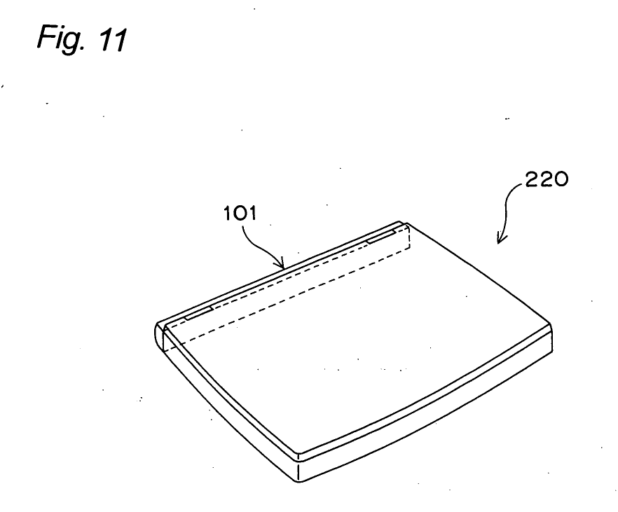

FIG. 1 shows one example of the direct methanol fuel cell. The direct methanol fuel cell 101 adopts a form in which an electric power generating part 120 is immersed in liquid fuel 190 of methanol aqueous solution stored in a fuel tank 110, as apparent from FIG. 2 showing a perspective view of the fuel tank. As shown in FIG. 10, the form of the electric power generating part 120 is not limited to the immersed type of FIG. 1. Further, the direct methanol fuel cell 101 can, as shown in FIG. 11, be attached to a portable electronic apparatus 220 of for example, note-type personal computer and the like.

The direct methanol fuel cell 101 includes a liquid level detecting device 130 corresponding to one example of an impedance measuring device, to be hereinafter described, in addition to the fuel tank 110 and the electric power generating part 120 for the basic configuration. In the present embodiment, the direct methanol fuel cell 101 further includes an air supply part 140, a fuel supply part 150, a water recovering part 160, and a controlling device 170.

The fuel tank 110 is a tank for accommodating the electric power generating part 120, and has a liquid contacting parts formed with nonconductive material because the liquid level detecting device 130 measures an impedance value of the liquid fuel 190. In the present embodiment, the fuel tank 110 is formed by an insulating resin material, for example, polypropylene and the like.

The liquid fuel 190 in the fuel tank 110 is a methanol aqueous solution with a concentration of about 5% by weight, and is a pH-pre-adjusted liquid fuel in which formic acid is added in advance so as to have a pH value of the methanol aqueous solution of about 2.5 to about 3.0 in a fresh state of before starting of electric power generation, as mentioned above. An adding amount of the formic acid is about 0.05% to about 0.3% by weight. It is to be noted that since an electric power generating efficiency is the best, in the present embodiment, a methanol concentration is set to about 5% by weight, but the methanol concentration is not limited to about 5% by weight and may be changed in accordance with an equipment configuration of the direct methanol fuel cell 101.

The electric power generating part 120 includes, as a basic configuration, an anode electrode 121, a cathode electrode 122, and a solid polymer electrolyte membrane 123 sandwiched between the anode electrode 121 and the cathode electrode 122, and these components form a membrane electrode assembly (MEA). In the figure, one set of membrane electrode assembly having the above configuration is shown, but actually, a plurality of membrane electrode assemblies are connected in series.

The anode electrode 121 and the cathode electrode 122 are formed by a catalyst layer and an electrode, and the anode electrode 121 is connected to a negative electrode and the cathode electrode 122 to a positive electrode. The anode electrode 121 contacts the pH-pre-adjusted liquid fuel 190 in the fuel tank 110 because of the immersion state as mentioned above, so the anode electrode 121 is constantly supplied with the methanol. On the other hand, the air supplying part 140 including an air chamber 142 and an air supply pump 141 is connected to the cathode electrode 122, and the air chamber 142 to which the atmospheric air is blown by the air supply pump 141 is attached to the cathode electrode 122 with facing to the cathode electrode 122. The air chamber 142 is immersed in the pH-pre-adjusted liquid fuel 190, and as shown in FIG. 2, air inlet/outlet 142a, 142b extending from the air chamber 142 are led outward from the liquid fuel 190. Thus, although the electric power generating part 120 is immersed in the liquid fuel 190, the cathode electrode 122 is not in contact with the liquid fuel 190 and is exposed to the inside of the air chamber 142, and thus air is supplied to the cathode electrode 122.

The above mentioned chemical reaction occurs at the anode electrode 121 and the cathode electrode 122 configured in such a way. That is, at the anode electrode 121, the methanol and water react under catalysis containing platinum and ruthenium thereby generating hydrogen ions, electrons and carbon dioxide. The electrons are output to the outside as electric power through the anode electrode 121 and the hydrogen ions are traveled through the solid polymer electrolyte membrane 123 towards the cathode electrode 122 side. At the cathode electrode 122, the hydrogen ions are supplied with electrons from the cathode electrode 122, and react with the oxygen in air thereby generating water.

The solid polymer electrolyte membrane 123 contains hydrogen ion conductive membrane, and is preferably a proton conductive cation exchange membrane, for example, a membrane of perfluorosulfonic acid polymer of trademark “Nafion”. The membrane is more specifically, made of a copolymer of tetrafluoroethylene and perfluorovinyl ether sulfonic acid. Membranes of modified perfluorosulfonic acid polymer, polycarbon hydride sulfonic acid, and a compound material of two or more kinds of proton exchange membranes may also be used.

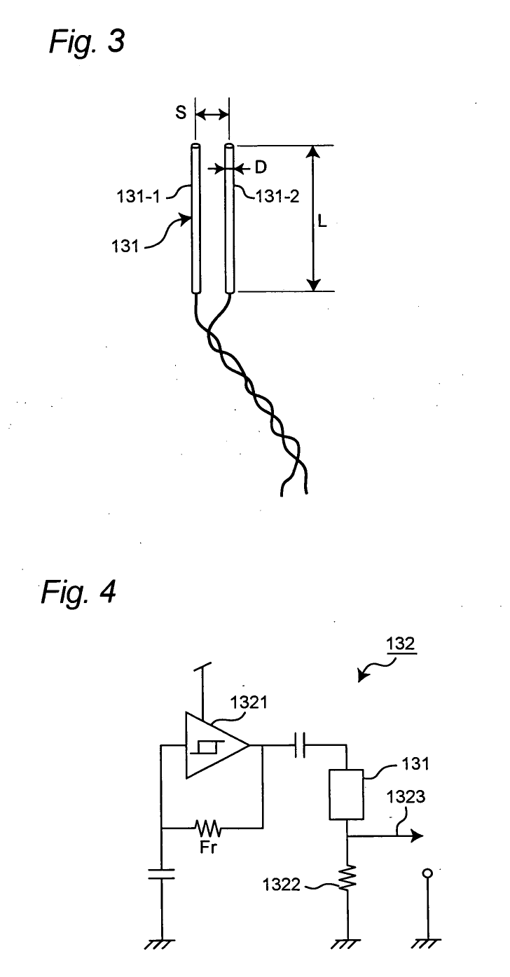

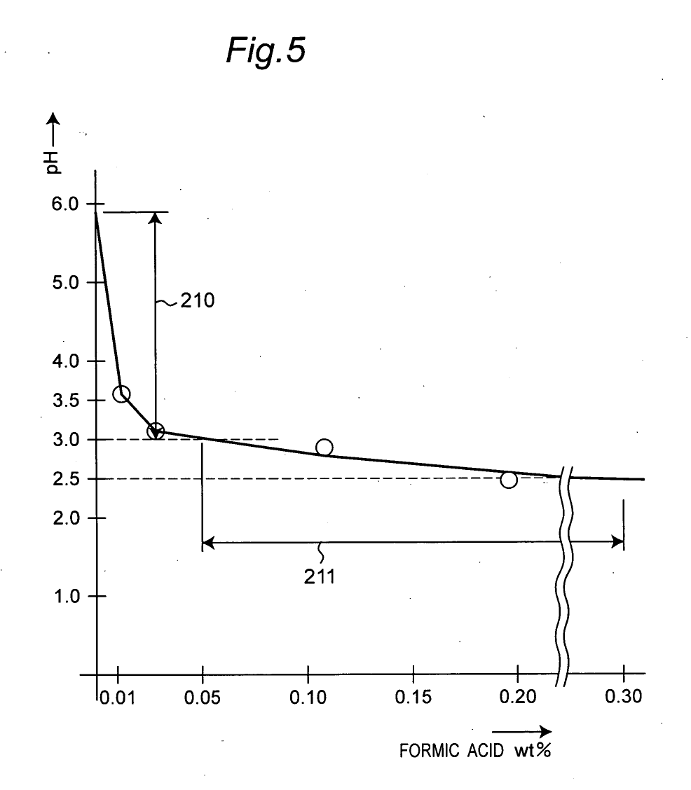

The level detecting device 130 includes a level electrode 131 and a level detecting circuit 132, and the controlling device 170. In order not to inhibit the catalysis of the MEA directly related to the electric power generating operation, it is important to remove the unnecessary metal ions from the liquid fuel 190. Thus the level electrode 131 is made of material such as platinum or gold, etc. Such level electrode 131, as shown in FIG. 3, is configured by arranging two rod shaped electrodes 131-1 and 131-2 made of material such as platinum or gold, parallel to each other with an appropriate spacing in between. In the present embodiment, each of the electrodes 131-1 and 131-2 is a wire member having a diameter D of 0.3 mm and a length L of 18 mm, and is arranged parallel to each other with a spacing S of 2 mm. It is to be noted that for the diameter D, the length L, the spacing S, and the shape of the electrodes 131-1 and 131-2 are selected so as to be appropriate in accordance with the form and the like of the electric power generating part 120. Lead wire connected to each of the electrodes 131-1 and 131-2 is coated with an insulating material of “Teflon” (registered trademark) so as not to influence the output value of the level detecting circuit 132 when the lead wires are immersed in the methanol aqueous solution 190. Further, the coating also has an effect of preventing corrosion by the formic acid contained in the methanol aqueous solution 190. The material of the level electrode 131 is selected from a point of view of the corrosive resistance to the formic acid and is not limited to platinum or gold. So, the material only needs to be a material that is corrosive-free to acid electrolyte, and carbon rod etc. may be used. Further, the material itself does not need to be platinum or gold, and the electrode surface may be configured by plating with material such as platinum or gold.

Such level electrode 131 is arranged at a position where an immersed amount of the level electrode 131 changes in accordance with the level change of the liquid fuel 190 in the fuel tank 110. More specifically, each of the electrodes 131-1 and 131-2 is extended along the gravity direction, and is arranged in a state such that, for example, the liquid level of the liquid fuel 190 is positioned at substantially the central portion of the electrodes 131-1 and 131-2 in a state an upper end 120a of the electric power generating part 120 is completely immersed in the liquid fuel 190 as shown in FIG. 1, and lower parts 131a of the electrodes 131-1 and 131-2 are still immersed in the liquid fuel 190 when the upper end 120a of the electric power generating part 120 starts exposing from the liquid fuel 190.

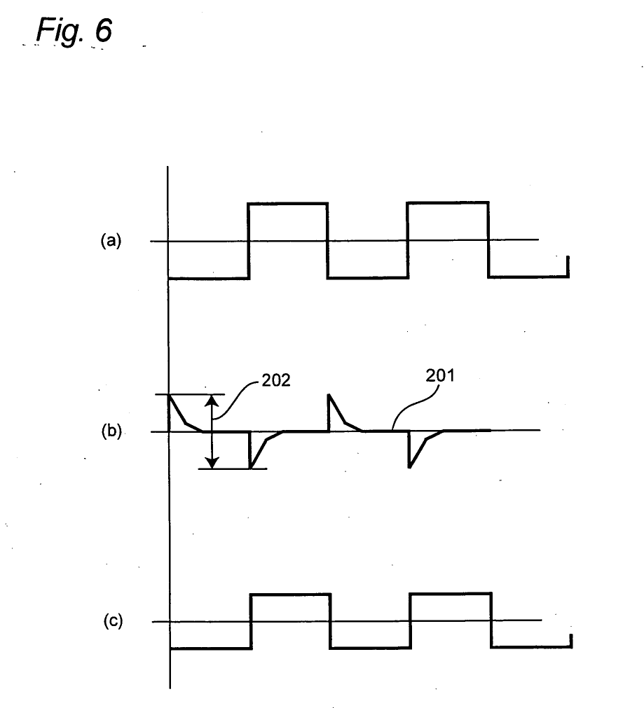

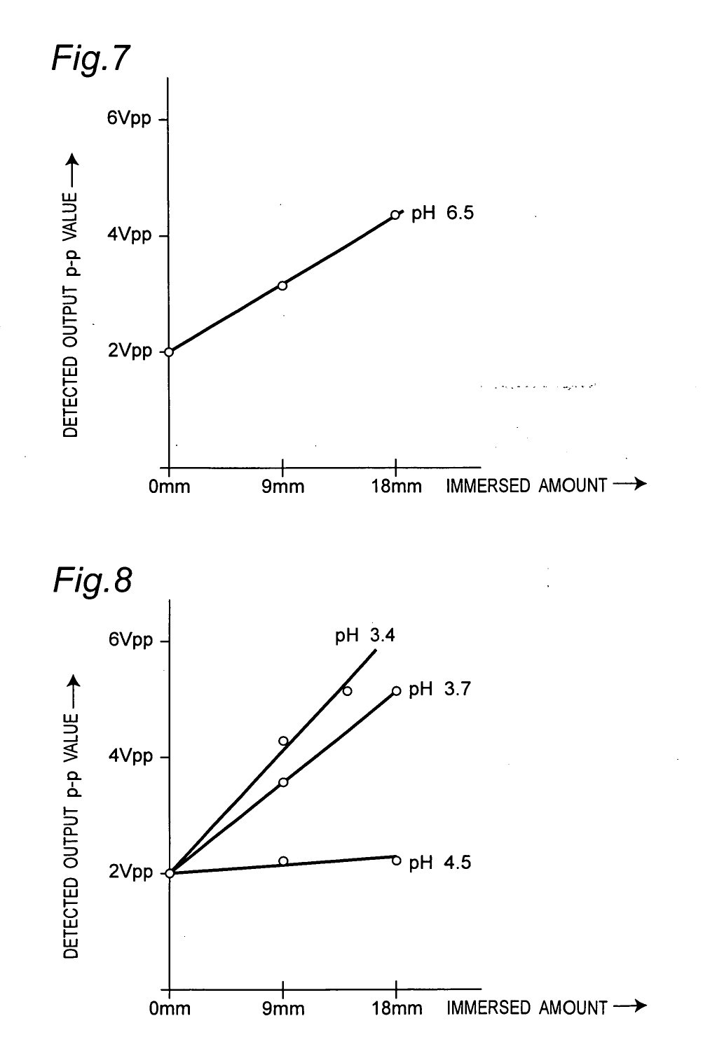

As shown in FIG. 4, the liquid detecting circuit 132 includes, as a basic configuration, an oscillator 1321 serving as a drive power source for measuring the impedance value of the level electrode 131, and a resistor 1322 connected in series to the level electrode 131 and the oscillator 1321. The liquid detecting circuit 132 outputs a detected output 1323 as a detection value which corresponds to a voltage divided by the level electrode 131 and resistor 1322. In the present embodiment, as an example, the oscillator 1321 outputs a rectangular wave shown in (a) of FIG. 6 oscillated at about 350 kHz, and the resistance 1322 is 10 kΩ. It is to be noted the each element configuring the level detecting circuit 132 is designed so as to obtain a suitable detected output 1323 in accordance with each value of the diameter D, length L, and spacing S of the level electrode 131. In the present embodiment, the rectangular wave of about 350 kHz is used as mentioned above, but a wave is not limited to the rectangular wave, and it is apparent that the same effect can be obtained with a sine wave. Further, the frequency is preferably a high frequency of greater than or equal to 100 kHz for alternating current so as not to cause extra component such as, electrolyzation of the liquid fuel, and the like.

As mentioned above, when the pH value of the methanol aqueous solution 190 is around about 3, the liquid electrode 131 acts as an effective resistance rather than acting as a electrostatic capacitance. Thus, a direct current power source of for example, 5 V may simply be arranged in place of the oscillator 1321. Such change in circuit in the level detecting circuit 132 can be done within a range easily contrived by those skilled in the art.

The detected output 1323 of the level detecting circuit 132 is provided to the controlling device 170. The controlling device 170 stores the relational information between the detected output 1323 and the immersed amount of the level electrode 131, as shown in for example, FIG. 8, and converts the detected output 1323 provided from the level detecting circuit 132 to the above immersed amount. In the controlling device 170, a part having such conversion function is a conversion part 171.

The fuel supply part 150 includes a undiluted solution tank 151 for storing undiluted methanol 191, a fuel supply pump 153 having a discharge side connected to the fuel tank 110, a switching valve 152, connected to the undiluted solution tank 151 and a water tank 162 to be hereinafter described, for feeding the undiluted methanol 191 or water 192 to the fuel supply pump 153, and a concentration sensor 154 immersed in the liquid fuel 190 of the fuel tank 190 for measuring the methanol concentration of the liquid fuel 190. The undiluted methanol 191, as mentioned above, is a pH-pre-adjusted undiluted methanol 191 in which the formic acid is added at about 0.05 to about 0.3% by weight so as to have the pH value of the methanol at about 2.5 to about 3.0 in advance in the fresh state before the start of the electric power generation.

The switching valve 152, the fuel supply pump 153, and the concentration sensor 154 are connected to the controlling device 170. In the present embodiment, since the methanol concentration of the liquid fuel 190 is about 5% by weight as mentioned above, thus the controlling device 170 switches the switching valve 152 to the undiluted solution tank 151 side or the water tank 162 side so as to have the methanol concentration at about 5% by weight based on the methanol concentration detected by the concentration sensor 154 and starts the fuel supply pump 153. Thus, the undiluted methanol 191 or water 192 is supplied to the fuel tank 110, and the methanol concentration in the liquid fuel 190 is adjusted to about 5% by weight.

The water recovering part 160 includes a condenser 161, connected to an air outlet 142b of the air chamber 142, for condensing the moisture generated at the cathode electrode 122 to distinguish between air and water; and a water tank 162, connected to the condenser 161, for collecting the separated water 192. The water 192 recovered to the water tank 162 is supplied to the switching valve 152 as mentioned above.

Operation of the direct methanol fuel cell 101 configured as above will now be explained including a method for detecting the liquid level of the liquid fuel 190 in the fuel tank 110 using the liquid level detecting device 130.

The pH adjusted undiluted methanol 191 is, as mentioned above, supplied to the fuel supply pump 153 from the undiluted solution tank 151 by the switching valve 152, and supplied to the fuel tank 110. The liquid fuel 190 containing the methanol aqueous solution that has a concentration of about 5% by weight and that is pH adjusted is supplied to the anode electrode 121 of the electric power generating part 120. The chemical reaction with the methanol is performed, as mentioned above, at the anode electrode 121. On the other hand, the air is supplied to the air chamber 142 by the air supply pump 141, and the chemical reaction with the oxygen in the air is performed at the cathode electrode 122 of the electric power generating part 120. As mentioned above, the electric power is generated in the electric power generating part 120 through such chemical reactions, and electric power is supplied outside from the electric power generating part 120. In the power generating operation, a temperature of the entire electric power generating part 120 increases to about 60° C. due to a heat of reaction, temperature rise caused by direct reaction because of the cross over at the cathode electrode 122, and the like. At the anode electrode 121, carbon dioxide is generated by chemical reaction, and carbon dioxide gas is discharged outward by the pressure difference through a gas/liquid separating membrane (not shown) arranged at an upper part of the fuel tank 110.

The discharge air containing water vapor of the reaction at the cathode electrode 122 is distinguished between water 192 and discharge air at the condenser 161, and the discharge air is discharged to the outside whereas water 192 is supplied again to the fuel tank 110 through the water tank 162 and the switching valve 152, thereby recycling the water.

The methanol in the fuel tank 110 begins to consume with the above described electric power generating operation. The change in methanol concentration by methanol consumption is detected by the concentration sensor 154, and based on the detection result, the fuel supply part 150 is operation controlled by the controlling device 170, as mentioned above, thereby supplying undiluted methanol 191 and water 192 to the fuel tank 110. Due to the adding operation of the liquid fuel 190, and further the evaporation of moisture and the like, the level of the liquid fuel 190 of the fuel tank 110 changes. Therefore, in order to continue the electric power generating operation while immersing the electric power generating part 120 all the time in the liquid fuel 190, and performing a suitable methanol concentration management, the level management of the liquid fuel 190 becomes essential.

The level management is performed by the above mentioned liquid level detecting device 130 and the controlling device 170.

As described above, the level electrode 131 of the liquid level detecting device 130 is arranged at a suitable position with respect to the electric power generating part 120, and the conversion part 171 of the controlling device 170 includes relational information between the detected output 1323 from the level detecting circuit 132 and the immersed amount of the level electrode 131. Thus the controlling device 170 performs level control between an upper liquid level 131b and a lower liquid level 131c based on the detected output 1323 with the upper end 120a of the electric power generating part 120 immersed completely in the liquid fuel 190. It is to be noted that in FIG. 1, the upper liquid level 131b and the lower liquid level 131c are shown for the sake of explanation, so set positions can be freely set. However, it is wrong that the liquid level is lower than or equal to the upper end 120a of the electric power generating part 120 as described above. Thus the lower liquid level 131c is set to be at least slightly above the upper end 120a.

As described above, the undiluted methanol 191 and the liquid fuel 190 have the pH value or the electrical conductivity of the liquid fuel 190 adjusted in advance so as to have the above mentioned minor change region 211 where the liquid level detecting device 130 detects the change in the liquid level of the liquid fuel 190 and does not detect the change in pH value of the liquid fuel 190 at the initial state of before the starting of the electric power generation. Therefore, the liquid level detecting device 130 can detect the liquid level of the liquid fuel 190 reliably and accurately during the electric power generation even at the starting of the electric power generation, in particular, in the above described region 210 where the pH value changes steeply, without being influenced by the change in pH value or electrical conductivity of the liquid fuel 190.

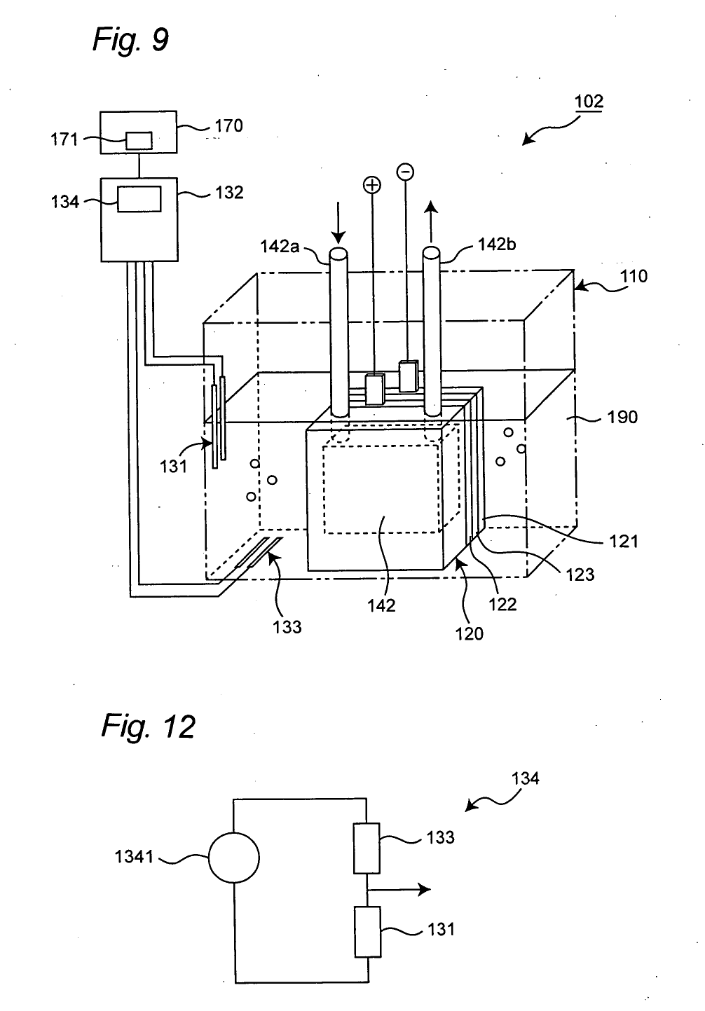

Even with the pH-pre-adjusted liquid fuel 190, the pH value of the liquid fuel 190 changes by the slight formic acid generation caused by the continuation of the electric power generating operation. As described above, the liquid level detecting device 130 can detect the liquid level change without being influenced by the slight change in pH value, but in order to more precisely perform the liquid level detection, a direct methanol fuel cell 102 shown in FIG. 9 can be configured as a modified example of the direct methanol fuel cell 101. In FIG. 9, illustration of the configuration relating to the air supply part 140, the fuel supply part 150, and the water recovering part 160 are omitted.

The direct methanol fuel cell 102 has a configuration in which a reference electrode 133 is added to the configuration of the direct methanol fuel cell 101, and a correction circuit part 134 is included in the level detecting circuit 132. The reference electrode 133 is included in the liquid level detecting device 130, is positioned to be submerged completely in the liquid fuel 190 in the fuel tank 110 regardless of the level change of the liquid fuel 190, and has the same configuration as the level electrode 131. Further, the reference electrode 133 is connected to the correction circuit part 134. The correction circuit part 134 is a circuit for correcting liquid level detection error of the level electrode 131, caused by the change in pH value of the liquid fuel 190, on the basis of the impedance value of the reference electrode 133 as the reference. A specific circuit configuration of the correction circuit part 134 can use a configuration substantially similar to the circuit configuration of the level detecting circuit 132 shown in FIG. 4, by way of one example. That is, the correction circuit part 134 has a configuration in which an external voltage source 1341 for outputting alternating current or rectangular wave is connected to the level electrode 131 and the reference electrode 133, and a divided voltage generated by the electrodes is output to the controlling device 170, as shown in FIG. 12. In such configuration, since the reference electrode 133 is completely submerged in the liquid fuel 190, the resistance value thereof fluctuates with the change in pH value of the liquid fuel 190. Further, the impedance value of the level electrode 131 fluctuates with the level change of the liquid fuel 190 and the change in pH value. Thus, when the divided voltage value of the level electrode 131 and the reference electrode 133 is detected, the change in the impedance value caused by the change in pH value of the liquid fuel 190 is canceled out by the resistance value of the reference electrode 133. Thus only the liquid level can be detected independently of the change in pH value.

In the direct methanol fuel cell 102 configured in such a way, when the pH value of the liquid fuel 190 in the fuel tank 110 is substantially uniform, that is, when the pH value or the electrical conductivity of the liquid fuel 190 at the neighborhood of the reference electrode 133 and the level electrode 131 is substantially uniform, the relative output values of the reference electrode 133 and the level electrode 131 with respect to the pH value does not change and is constant. Thus, the level detecting circuit 132 outputs only the change in the output of the level electrode 131 caused only by the level change, in which the pH value change of the liquid fuel 190 is canceled. Thus, the direct methanol fuel cell 102 is able to correct the change in pH value of the liquid fuel 190, thereby providing more accurate level information. Further, since the fuel cell generates heat through the electric power generating operation, a temperature of the liquid fuel also fluctuates. Due to the temperature change of the liquid fuel, the pH value also changes. But by adopting the configuration of the correction circuit part 134, a stable detection is possible also for the temperature change of the liquid fuel 190.

In the above explanation, the fuel cell of the type in which the electric power generating part 120 is immersed in the liquid fuel 190, as shown in FIG. 1, is given by way of example. However, a fuel cell to where the liquid level detecting device 130 is applicable is not limited to the type of FIG. 1, and may be a direct methanol fuel cell 250 having a configuration, as shown in FIG. 10, for example, in which the pH-pre-adjusted liquid fuel 190 is supplied from an intermediate tank 251 for storing the liquid fuel 190 to the anode electrode 121 of an electric power generating part 252. In FIG. 10, a reference number 253 is a pump for performing circulation of the liquid fuel 190 between the intermediate tank 251 and the electric power generating part 252, and a reference number 254 is a pump for supplying the pH value adjusted undiluted methanol 191 from the undiluted solution tank 151 to the intermediate tank 251, and a reference number 255 is a pump for supplying water 192 from the water tank 162 to the intermediate tank 251.

### Second Embodiment

In the above explanation, the configuration of an inexpensive and high-precision level sensor has been explained in a view point of fuel supply, which is essential in fuel cell. For example, a method for using the liquid fuel in which the pH value is adjusted in advance by mixing the formic acid has also a direct effect on the stability of the electric power generating voltage. This will be described in more detail below.

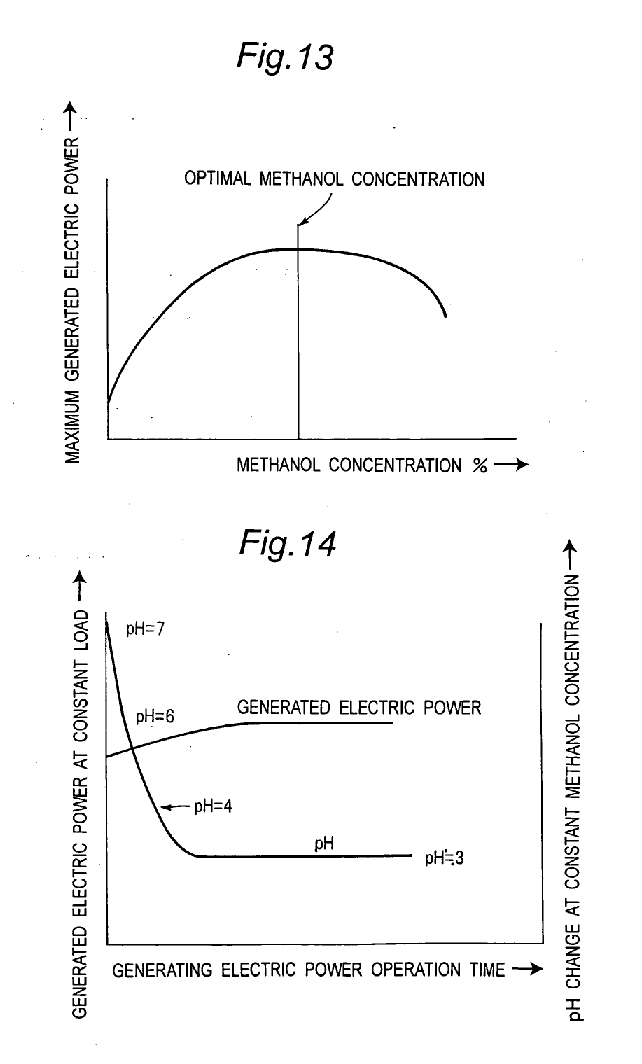

In the direct methanol fuel cell, as described above and as shown in FIG. 13, since the suitable methanol concentration at which the electric power in generating operation becomes satisfactory exists, the concentration management of the methanol aqueous solution during the electric power generating operation period is one of the important things. Thus, the concentration management of the methanol aqueous solution will first be explained.

Although measuring the methanol concentration by the density of the methanol aqueous solution using an areometer and the like is possible as a method for managing the concentration of the methanol aqueous solution, it is not preferable as a method for measuring the concentration in the fuel cell attached to the mobile equipment. Thus, a method for measuring the methanol concentration based on the electric power of generating electricity using the relationship between the electric power and the methanol concentration of the fuel cell is considered. However, as a general property of the fuel cell, the electric power of generating electricity is varied according to the fluctuation of the load connected to the fuel cell. Thus, the electric power of generating electricity cannot be simply used for the detection of the methanol concentration, and the electric power of generating electricity must be detected in a state that the load is constant.

Further, as mentioned above, the pH value of the liquid fuel is varied with a lapse of time of the electric power generating operation. According to the experiment of the applicants, the electric power of generating electricity is enhanced when the liquid fuel is on the acid side rather than when neutral, as shown in FIG. 14. The acidity of the liquid fuel, as noted in the first embodiment, is stabilized at about 3 of the pH value with the lapse of time of the electric power generation. Further, after the pH value becomes constant at about 3, the output electric power of the fuel cell substantially constant. Thus it is apparent that a control method that the electric power supplied to a constant load becomes to be at maximum with respect to the concentration change of the liquid fuel is very effective.

To this end, as the fuel used in the direct methanol fuel cell, by using the liquid fuel in which the formic acid is added and the pH value is adjusted in advance, as in first embodiment, instead of the neutral methanol aqueous solution, and by detecting the methanol concentration of the liquid fuel; stable concentration management is possible from the initial stage of the electric power generation to after continuous operation. The adding amount of the formic acid is greater than or equal to 0.05% by weight as described in the first embodiment.

According to the liquid fuel in which the concentration of the methanol aqueous solution is managed as described above and the formic acid is mixed at 0.05 to 0.30% by weight in advance to the neutral methanol aqueous solution, as explained in first embodiment, the electric power enhancement is actually seen as explained below. That is, the power density is 48 mW/cm² when the formic acid is not mixed, the power density is about 52 mW/cm² when the formic acid is added at 0.05% by weight, and thus the electric power is enhanced by about ten percent. Further, the power density is about 54 mW/cm² when the formic acid is mixed at 0.3% by weight, and the power density is 54 mW/cm² when the formic acid is mixed at 0.5% by weight. Thus, compared to the case in which the formic acid is not mixed, an improvement in the obtained electric power with the liquid fuel, in which the formic acid is added at 0.05 to 0.30% by weight, is recognized.

As described above, it is very important to maintain the efficiency of the electric power generation in the fuel cell to be constant, and is essential to manage the pH value of the methanol aqueous solution which is one of the fluctuating causes. As explained in the first embodiment, by mixing the formic acid at 0.05 to 0.3% by weight in advance to the neutral methanol aqueous solution, the pH value can be made substantially constant regardless of the elapse in the electric power generating time. Thus, in the second embodiment, as well, the fuel for fuel cell in which the formic acid is added at 0.05 to 0.3% by weight in advance to the neutral methanol aqueous solution has an effect in the electric power generating efficiency.

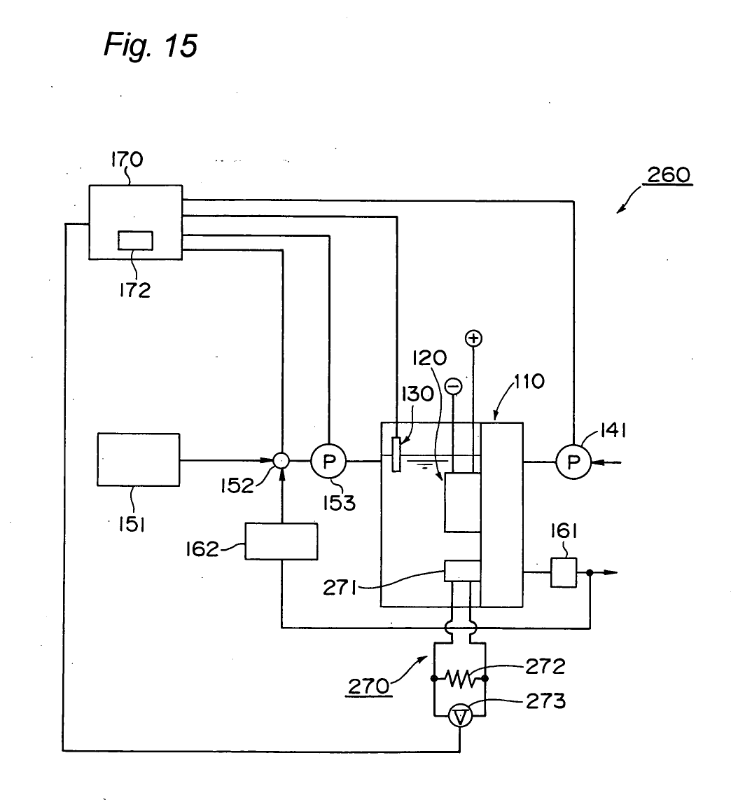

FIG. 15 shows a configuration including a concentration detector 270 of the methanol aqueous solution in a direct methanol fuel cell 260 using the fuel for fuel cell in which the formic acid is mixed at 0.05 to 0.3% by weight in advance to the neutral methanol aqueous solution. The concentration detector 270 includes an electric power generating part for concentration detection 271, having the same configuration as the electric power generating part 120, for generating electric power; a resistor 272, connected to the electric power generating part for concentration detection 271 for serving as a load of constant value; and a voltmeter 273 for measuring output of the electric power generating part for concentration detection 271 and sending the result to the controlling device 170. It is to be noted that the methanol aqueous solution same as that supplied to the electric power generating part 120 is supplied to the electric power generating part for concentration detection 271. Further, one example of a methanol concentration determining device is configured by the concentration detector 270 and a conversion part 172 included in the controlling device 170. The conversion part 172 has a function for storing the relational information between a generated electric power of the electric power generating part for concentration detection 271 and the methanol concentration, and converting the output value supplied from the voltmeter 273 to the methanol concentration.

By using the methanol aqueous solution adjusted in pH value in advance, the pH value of the liquid fuel is constant at substantially 2.5 to 3 irrespective of the elapse in electric power generating time. Thus, according to the relevant configuration, the controlling device 170 can monitor the methanol concentration by using the output voltage of the electric power generating part for concentration detection 271 based on the relationship between the output voltage of the electric power generating part for concentration detection 271 supplied from the voltmeter 273 and the methanol concentration.

The direct methanol fuel cell 260 shown in FIG. 15 is an example configured based on the direct methanol fuel cell 101, but configurations of arranging the concentration detector 270 with respect to the direct methanol fuel cell 102 shown in FIG. 9 and the direct methanol fuel cell 250 shown in FIG. 10 may be adopted.

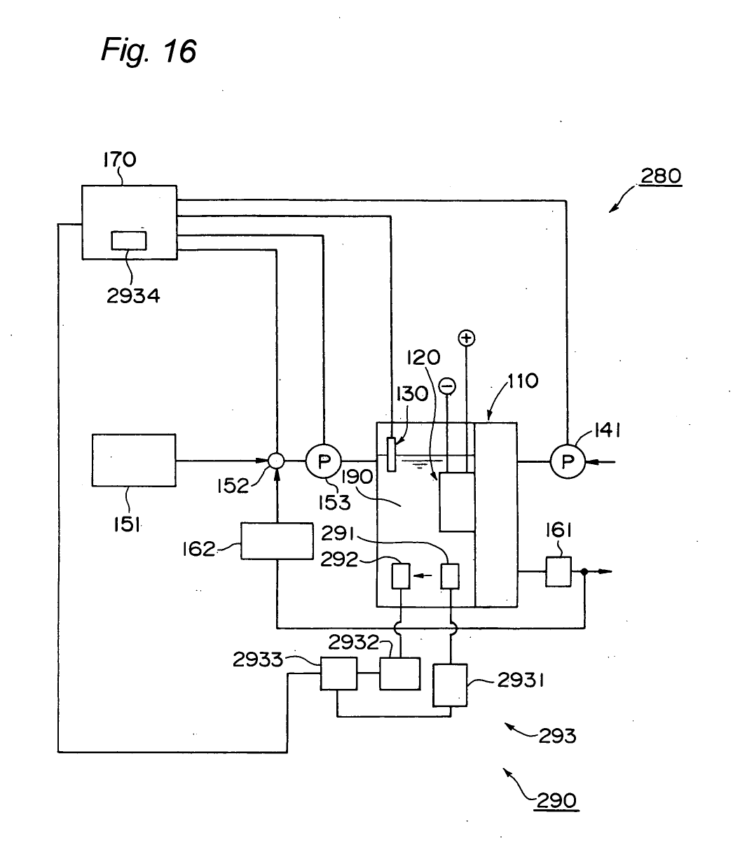

Other configuration example of the methanol concentration determining device will now be explained with reference to FIG. 16.

A methanol concentration determining device shown in FIG. 16 is a device for detecting the density change, that is, the concentration change of the methanol aqueous solution by using change of propagation speed of the oscillating wave in the methanol aqueous solution. In the present embodiment, acoustic wave is used as the oscillating wave. Generally, the propagation speed C of the acoustic wave is expressed by an equation:
C=√(K/ρ)
where K is a bulk modulus, and ρ is a density of substance in which the acoustic wave propagates.

Further, the density of the liquid fuel 190, and further, the methanol concentration of the liquid fuel 190 can be obtained by measuring the propagation speed C of the acoustic wave propagated through the liquid fuel 190 based on speed/concentration relationship. The speed/concentration relationship is such that, as one example, the propagation speed C is about 1495 m/s when the methanol concentration is 0% by weight and the propagation speed C is about 1537 m/s when the methanol concentration is 10% by weight.

On the other hand, the formic acid is generated by the electric power generating operation in the direct methanol fuel cell, as described above. Since a density of methanol is 0.79 g/cc whereas a density of the formic acid is 1.22 g/cc, the presence/absence and the amount of the formic acid in the methanol aqueous solution greatly influences the density of the methanol aqueous solution. As noted above, even if the electric power generating operation is continued, the formic acid is stabilized at the substantially constant concentration without continuously increasing. This phenomenon is also used in the methanol concentration determining device for detecting the concentration change of the methanol aqueous solution based on the change of the propagation speed of the acoustic wave. That is, as explained above, the formic acid is mixed so that the formic acid concentration becomes about 0.05 to about 0.3% by weight in the methanol aqueous solution in the state before the starting of electric power generation, in other words, so that the formic acid concentration in the methanol aqueous solution maintains a substantially constant state irrespective of the elapsed time from the start of the electric power generation. By adjusting the concentration of the formic acid in advance, the methanol concentration of the liquid fuel 190 can be obtained by measuring the propagation speed C with the influence of the formic acid in an extremely reduced state.

In the method for detecting the change of methanol concentration in the methanol aqueous solution using the oscillating wave, in order to reduce the influence of the formic acid concentration and enhance the detection precision, it is preferable that the concentration of the formic acid is adjusted so that the formic acid is contained at a concentration of about 0.1% by weight for a lower limit and about 0.3% by weight for an upper limit, more preferably at a concentration of about 0.3% by weight.

FIG. 16 shows a configuration of including a concentration detecting device 290 in a direct methanol fuel cell 280 using the fuel for fuel cell in which the formic acid is mixed in the neutral methanol aqueous solution so that the formic acid concentration becomes at 0.1 to 0.3% by weight in advance. The concentration detecting device 290 corresponds to one example of the methanol concentration determining devices. The concentration detecting device 290 includes a wave transmitting part 291, a wave receiving part 292, and a propagation speed determining part 293. The propagation speed detecting part 293 includes a pulse voltage applying device 2931 connected to the wave transmitting part 291, a wave receiving circuit 2932 connected to the wave receiving part 292, a propagation time comparing circuit 2933, and a conversion part 2934 included in the controlling device 170.

The wave transmitting part 291 and the wave receiving part 292 are formed by for example, a pair of piezoelectric elements, and when a pulse voltage is applied to the wave transmitting part 291 by the pulse voltage applying device 2931, the wave transmitting part 291 oscillates and emits an acoustic wave serving as the oscillating wave into the liquid fuel 190. Further, the wave pulse voltage applying device 2931 sends a signal notifying wave transmission to the propagation time comparing circuit 2933 simultaneously with applying the pulse voltage to the wave transmitting part 291. The wave receiving part 292 receives the acoustic wave emitted by the wave transmitting part 291, and the wave receiving circuit 2932 sends a signal notifying reception to the propagation time comparing circuit 2933. The propagation time comparing circuit 2933 obtains a time difference of each signal from the pulse voltage applying device 2931 and the receiving circuit 2932, and further obtains the propagation speed of the acoustic wave from the wave transmitting part 291 to the wave receiving part 292 based on the time difference and a distance between the electrodes. The propagation speed value is then sent to the conversion part 2934. The conversion part 2934 has speed/concentration relational information such as mentioned above of the propagation speed and the methanol concentration stored therein, and obtains the methanol concentration based on the relational information. The propagation time comparing circuit 2933 may send information of the time difference to the conversion part 2934, and the conversion part 2934 may obtain the methanol concentration based on relational information of the time difference and the methanol concentration. Conversion method is not limited to the method using the relational information, and a known method, such as, a method for obtaining through arithmetic expression and the like may also be used.

The density of the liquid fuel 190 changes by the temperature of the liquid fuel 190, and thus in order to obtain the concentration more accurately, the temperature of the liquid fuel 190 is measured, and the concentration is obtained in consideration of the temperature parameter at the conversion part 2934.

As described above, according to the methanol concentration determining device using the oscillating wave, compared to when using the concentration detector 270, the electric power generating part for concentration detection 271, which has the same configuration as the electric power generating part 120 and generating the electric power, does not need to be arranged, and thus the configuration is simplified, and cost reduction and space reduction can be achieved. Further, since consumption of liquid fuel 190 at the electric power generating part for concentration detection 271 does not occur, the liquid fuel is more effectively used for the electric power generation.

### Third Embodiment

The liquid level detecting device 130 explained in the first embodiment is one configuration example of the impedance measuring device, but the impedance measuring device performs not only the above mentioned liquid level measurement but function described below by measuring the impedance between two electrodes immersed in the liquid fuel 190. Namely, the impedance measuring device determines a state of the liquid fuel 190 in a direct methanol fuel cell, in other words, has a sensor function with respect to the liquid fuel 190.

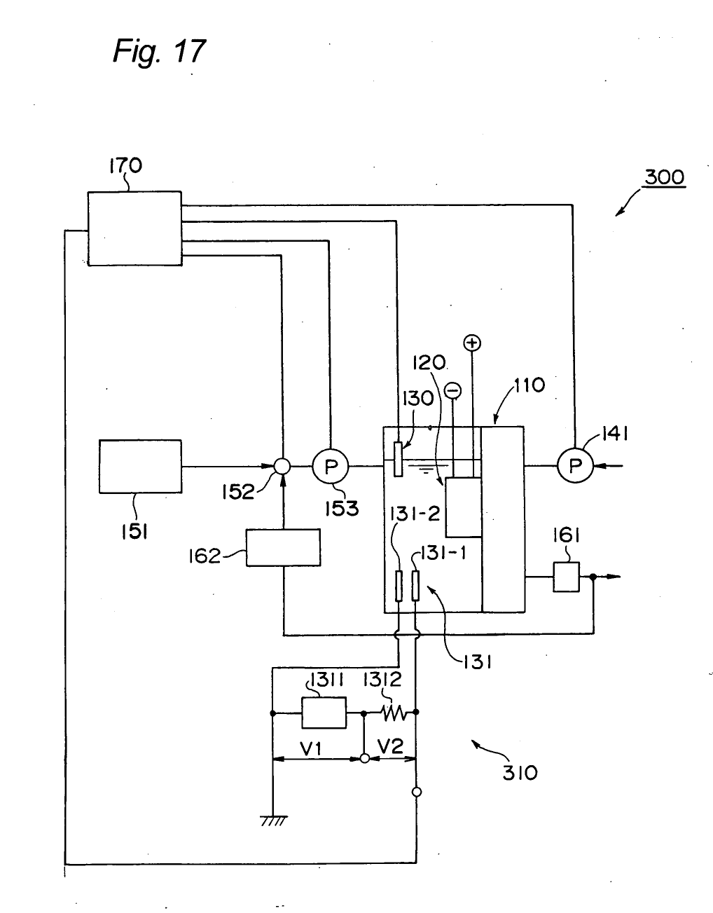

FIG. 17 shows a direct methanol fuel cell 300 including a temperature measuring device 310 corresponding to other configuration example of the impedance measuring device. The temperature measuring device 310 forms a temperature sensor by using properties that the electrical conductivity is produced in the methanol aqueous solution by mixing the formic acid of a predetermined amount to the methanol aqueous solution acting as the insulating substance, and the electrical conductivity has a temperature characteristic when the acid electrolyte exists at a constant concentration. It is to be noted that the methanol aqueous solution is a liquid having methanol concentration of about 5% by weight and containing the formic acid at concentration of 0.05% by weight for a lower limit and 0.30% by weight for an upper limit, as similar to the above mentioned embodiment.

The temperature measuring device 310 includes an electrode 131, an oscillator 1311, and a resistor 1312. The electrodes 131-1 and 131-2 are arranged parallel to each other with an appropriate spacing in the fuel tank 110 so as to be immersed in the liquid fuel 190. A voltage V1 output from the oscillator 1311 is applied to the electrodes 131-1 and 131-2 via the reference resistor 1312. In the present embodiment, the oscillator 1311 sends sine wave. A voltage V2 of the reference resistor 1312 which is divided between the electrodes 131-1 and 131-2 and the reference resistor 1312 is measured to obtain an equivalent resistance at high frequency between the electrodes 131-1 and 131-2. As one embodiment, using the reference resistance of 470Ω, the oscillator 1311 generates sine wave of 500 kHz, 5V p-p, and an output of the oscillator 1311 is applied to the electrodes 131-1 and 131-2. Thereafter, the equivalent resistance at high frequency between the electrodes 131-1 and 131-2 for when the temperature of the liquid fuel 190 is 27° C., 40° C., and 50° C. is obtained. As a result, the temperature and the equivalent resistance value of the liquid fuel 190 is 369Ω at 27° C., 313Ω at 40° C., and 288Ω at 50° C.

Correlation is achieved between the equivalent resistance value at high frequency between the electrodes and the temperature of the liquid fuel 190. Thus, by measuring an impedance at high frequency between the electrodes, the temperature of the liquid fuel 190 can be estimated. Therefore the temperature measuring device 310 functions as a satisfactory temperature sensor.

The configuration appropriately combining each of the above mentioned embodiments and the variant may also be adopted.

The present invention is also applicable to direct methanol fuel cell.

By appropriately combining the arbitrary embodiments of the above described various embodiments, the effects thereof are obtained.

The present invention is sufficiently described in relation to the preferred embodiments with reference to the accompanying drawings, but various changes and modifications will be apparent to those skilled in the art. Such changes and modifications are to be understood as included within the scope of the present invention as defined by the appended claims unless they depart therefrom.

Further, the entire contents of disclosures of specifications, drawings and claims of Japanese Patent Application No. 2004-269464 filed on Sep. 16, 2004, and Japanese Patent Application No. 2005-228262 filed on Aug. 5, 2005 are hereby incorporated entirely by reference.

What is claimed is:

1. A direct methanol fuel cell comprising:
an anode electrode configured to be supplied with a liquid fuel of methanol aqueous solution; a cathode electrode configured to be supplied with air for oxidation; and a solid polymer electrolyte membrane configured to be sandwiched between the anode electrode and the cathode electrode and contain a hydrogen ion conductive membrane,
the direct methanol fuel cell configured to generate an electric power through chemical reaction at the anode electrode and the cathode electrode,
the methanol aqueous solution, supplied to the anode electrode, containing formic acid at a concentration having a lower limit of 0.05% by weight and an upper limit of 0.30% by weight in advance before start of the chemical reaction.

2. The direct methanol fuel cell as claimed in claim 1, further comprising a methanol concentration determining device configured to determine a methanol concentration in the liquid fuel.

3. The direct methanol fuel cell as claimed in claim 2, the methanol concentration determining device including:
an anode electrode configured to be supplied with the liquid fuel; a cathode electrode configured to be supplied with air for oxidation; a solid polymer electrolyte membrane configured to contain a hydrogen ion conductive membrane; and a voltmeter configured to measure an output voltage obtained from the anode electrode and the cathode electrode through the chemical reaction at the anode electrode and the cathode electrode,
the methanol concentration determining device configured to determine the methanol concentration based on relationship between the output voltage and the methanol concentration.

4. The direct methanol fuel cell as claimed in claim 2, the methanol concentration determining device including:
a wave transmitting part and a wave receiving part configured to be immersed in the liquid fuel; and a propagation speed determining part connected to the wave receiving part and configured to determine a propagation speed of an oscillating wave propagating through the liquid fuel from the wave transmitting part to the wave transmitting part,
the methanol concentration determining device configured to determine the methanol concentration based on relationship between the propagation speed and the methanol concentration.

5. The direct methanol fuel cell as claimed in claim 1, further comprising:
two electrodes configured to be arranged with immersed in the liquid fuel; and an impedance measuring device electrically connected to the electrodes and configured to measure an impedance between the electrodes and determine state of the liquid fuel.

6. A direct methanol fuel cell comprising:
an electric power generating part including an anode electrode supplied with a liquid fuel of methanol aqueous solution, a cathode electrode supplied with air for oxidation, and a solid polymer electrolyte membrane sandwiched between the anode electrode and the cathode electrode and containing a hydrogen ion conductive membrane; and configured to generate an electric power through chemical reaction at the anode electrode and the cathode electrode;
a fuel tank configured to store the methanol aqueous solution supplied to the anode electrode, the methanol aqueous solution containing formic acid at a concentration having a lower limit of 0.05% by weight and an upper limit of 0.30% by weight in advance before start of the chemical reaction; and
a liquid level detecting device including two level electrodes configured to be arranged at a position where an immersed amount of the level electrodes changes in accordance with level change of the liquid fuel in the fuel tank, and a level detecting circuit electrically connected to the level electrodes and configured to send a detected value according to the level of the liquid fuel; and the liquid level detecting device configured to detect the level of the liquid fuel based on relationship between the detected value and the immersed amount.

7. The direct methanol fuel cell as claimed in claim 6, the liquid level detecting device further including a reference electrode configured to be arranged at a position submerged completely in the methanol aqueous solution in the fuel tank irrespective of the level change of the liquid fuel and have a configuration same as the level electrodes,
the level detecting circuit further including a correction circuit part configured to correct liquid level detection error of the level electrodes caused by change in an electrical conductivity of the methanol aqueous solution on a basis of an impedance value at the reference electrode as the reference.

8. A method for detecting a liquid level of a liquid fuel in a direct methanol fuel cell including an anode electrode configured to be supplied with a liquid fuel of methanol aqueous solution, a cathode electrode configured to be supplied with air for oxidation, and a solid polymer electrolyte membrane configured to be sandwiched between the anode electrode and the cathode electrode and contain a hydrogen ion conductive membrane; the direct methanol fuel cell configured to generate an electric power through chemical reaction at the anode electrode and the cathode electrode, the method comprising:
adjusting the liquid fuel of the methanol aqueous solution supplied to the anode electrode so as to contain formic acid at a concentration having a lower limit of 0.05% by weight and an upper limit of 0.30% by weight in advance before start of the chemical reaction;
arranging two level electrodes so that an immersed amount of the level electrodes changes in accordance with level change of a concentration adjusted liquid fuel; and
detecting the level of the liquid fuel based on relationship between an impedance between the level electrodes and the immersed amount.

9. A method for detecting a methanol concentration of a liquid fuel in a direct methanol fuel cell including an anode electrode configured to be supplied with a liquid fuel of methanol aqueous solution, a cathode electrode configured to be supplied with air for oxidation, and a solid polymer electrolyte membrane configured to be sandwiched between the anode electrode and the cathode electrode and contain a hydrogen ion conductive membrane; the direct methanol fuel cell configured to generate an electric power through chemical reaction at the anode electrode and the cathode electrode, the method comprising:
supplying a liquid fuel of methanol aqueous solution containing formic acid at a concentration having a lower limit of 0.05% by weight and an upper limit of 0.30% by weight in advance before start of chemical reaction to the anode electrode of a concentration detector, the concentration detector configured to include the anode electrode, the cathode electrode, and the solid polymer electrolyte membrane, a load of constant value being connected to the anode electrode and the cathode electrode, and generate an electric power through chemical reaction at the anode electrode and the cathode electrode; and
determining a methanol concentration through output change obtained from the anode electrode and the cathode electrode of the concentration detector.

10. A method for detecting a methanol concentration of a liquid fuel in a direct methanol fuel cell including an anode electrode configured to be supplied with a liquid fuel of methanol aqueous solution, a cathode electrode configured to be supplied with air for oxidation, and a solid polymer electrolyte membrane configured to be sandwiched between the anode electrode and the cathode electrode and contain a hydrogen ion conductive membrane, the direct methanol fuel cell configured to generate an electric power through chemical reaction at the anode electrode and the cathode electrode, the method comprising:
supplying a liquid fuel containing formic acid at a concentration having a lower limit of 0.05% by weight and an upper limit of 0.30% by weight in advance before start of the chemical reaction to the anode electrode;
propagating an oscillating wave in the liquid fuel and then obtaining a propagation speed of the oscillating wave; and
determining a methanol concentration based on relationship between the propagation speed and the methanol concentration.
